(19) United States
(12) Patent Application Publication
(10) Pub. No.: US 2026/0057220 A1
(43) Pub. Date: Feb. 26, 2026

(54) GENERATIVE ARTIFICIAL INTELLIGENCE FOR REDUCING NETWORK DIAGNOSTIC INTERVAL AND/OR IMPROVING NETWORK PERFORMANCE

(71) Applicant: Charter Communications Operating, LLC, St. Louis, MO (US)

(72) Inventors: Deependra Singh Rawat, Highlands Ranch, CO (US); Charles Ivan Cook, Castle Rock, CO (US)

(21) Appl. No.: 18/814,435

(22) Filed: Aug. 23, 2024

(51) Int. Cl. G06N 3/0475; G06F 16/9032; G06N 3/092

(52) U.S. Cl. CPC G06N 3/0475; G06F 16/90332; G06N 3/092

(57) ABSTRACT

At a large language model, convert a user query to an embedded version of the user query. Analyze the embedded version of the query with an orchestrator to obtain a notion of the query. Query a vector database with the notion of the query. Responsive to the querying of the vector database, retrieve a context with the orchestrator. Provide the context from the orchestrator to the large language model. Generate an answer to the user query with the large language model based on the user query and the context. Return the generated answer to the user.

### FIELD OF THE INVENTION

The present invention relates generally to the electrical, electronic and computer arts, and, more particularly, to artificial intelligence, networking, and network management.

### BACKGROUND OF THE INVENTION

A provider of network services, such as a cable multi-service operator (MSO), typically has a large number (on the order of millions) of field-deployed access devices. Such devices include, but are not limited to, cable modem termination system (CMTSs), RPDs (Remote PHY Devices, PHY is in reference to the Physical Layer of the well-known OSI 7-Layer reference model) and consumer premises equipment or customer premises equipment (CPE) devices such as D3.1 residential and SMB eMTA and 10G EPON Optical Line Terminal (OLT) and Service Optical Network Unit (S-ONU) devices, and the like. Maintaining and running this large network requires a significant amount of diagnostic effort from field technicians. Typically, a technician spends several hours to diagnose and mitigate an issue along with waiting to obtain a response from expert engineers who analyze and provide a “fix” for that issue. Distributed Access Architecture (DAA) deployment, including RPD (Remote PHY Device) deployment, is expected to provide an enhanced user experience. Regarding RPDs, refer, for example, to the Data-Over-Cable Service Interface Specifications DCA-MHAv2 Remote PHY Specification CM-SP-R-PHY-I04-160512, Cable Television Laboratories, Inc. May 12, 2016, expressly incorporated herein by reference in its entirety for all purposes.

In the field of machine learning and artificial intelligence (AI), a large language model (LLM) is a computational model that can handle natural language processing tasks such as classification. LLMs are artificial neural networks utilizing the transformer architecture. Fine-tuning can be used to adapt an LLM for specific tasks. Recently, some models instead employ prompt engineering.

### SUMMARY OF THE INVENTION

Principles of the invention provide generative artificial intelligence techniques for reducing network diagnostic interval and/or improving network performance. In one aspect, an exemplary computer-implemented method includes the operations of: at a large language model, converting a user query to an embedded version of the user query; analyzing the embedded version of the query with an orchestrator to obtain a notion of the query; querying a vector database with the notion of the query; responsive to the querying of the vector database, retrieving a context with the orchestrator; providing the context from the orchestrator to the large language model; generating an answer to the user query with the large language model based on the user query and the context; and returning the generated answer to the user.

In another aspect, an exemplary non-transitory computer readable medium includes computer executable instructions which when executed by a computer cause the computer to perform the method of: at a large language model, converting a user query to an embedded version of the user query; analyzing the embedded version of the query with an orchestrator to obtain a notion of the query; querying a vector database with the notion of the query; responsive to the querying of the vector database, retrieving a context with the orchestrator; providing the context from the orchestrator to the large language model; generating an answer to the user query with the large language model based on the user query and the context; and returning the generated answer to the user.

In a further aspect, an exemplary apparatus includes a memory; and at least one processor, coupled to the memory. The processor is operative to: at a large language model, convert a user query to an embedded version of the user query; analyze the embedded version of the query with an orchestrator to obtain a notion of the query; query a vector database with the notion of the query; responsive to the querying of the vector database, retrieve a context with the orchestrator; provide the context from the orchestrator to the large language model; generate an answer to the user query with the large language model based on the user query and the context; and return the generated answer to the user.

In still a further aspect, an exemplary system includes: a large language model configured to convert a user query to an embedded version of the user query; an orchestrator coupled to the large language model and configured to analyze the embedded version of the query to obtain a notion of the query; and a vector database coupled to the orchestrator. The orchestrator is further configured to: query the vector database with the notion of the query; responsive to the querying of the vector database, retrieve a context; and provide the context to the large language model. The large language model is further configured to: generate an answer to the user query based on the user query and the context; and return the generated answer to the user.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps (or a system wherein one or more such apparatuses are networked together, optionally with one or more other components). Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
reduce diagnostic interval and/or improve network performance;
reduced diagnostic interval in turn implies less service downtime;
less service downtime in turn enhances quality of experience for the customer;
increases accuracy of troubleshooting, which reduces false dispatches and pursuing incorrect solutions; and
enhance Distributed Access Architecture (DAA) deployment, including RPD (Remote PHY Device) deployment, by assisting in the diagnosis of issues that might be encountered when implementing these network upgrades.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8; and

FIG. 10 is an illustration of combined system block diagram/data flow diagram, according to an aspect of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Principles of the present disclosure will be described herein in the context of apparatus, systems, and methods for artificial intelligence, networking and network management. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

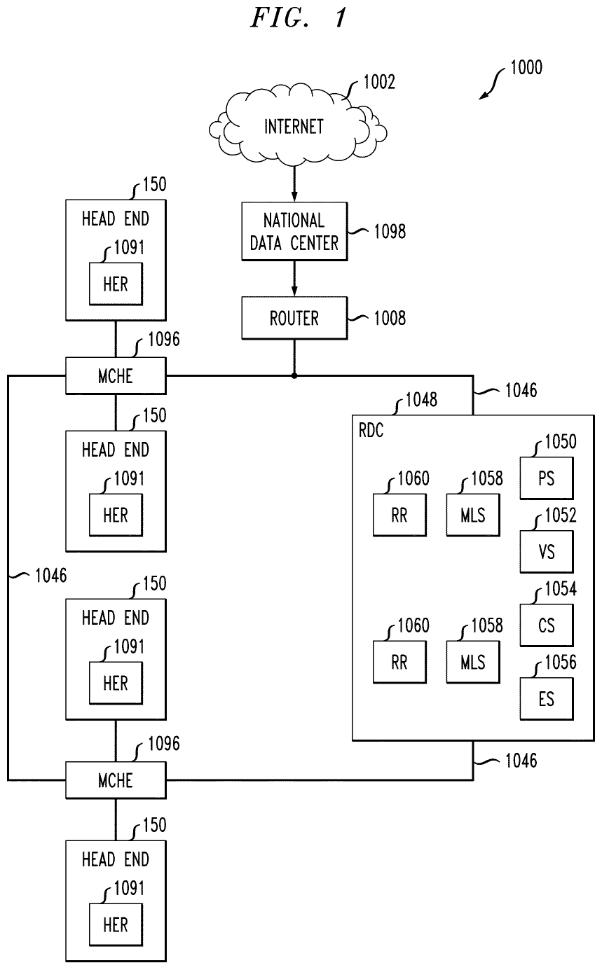

Certain aspects of cable and fiber systems, which are examples of a context in which aspects of the invention can be employed, will now be discussed; the skilled artisan will be familiar with current versions of/analogs to “classic” components discussed herein. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers(ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

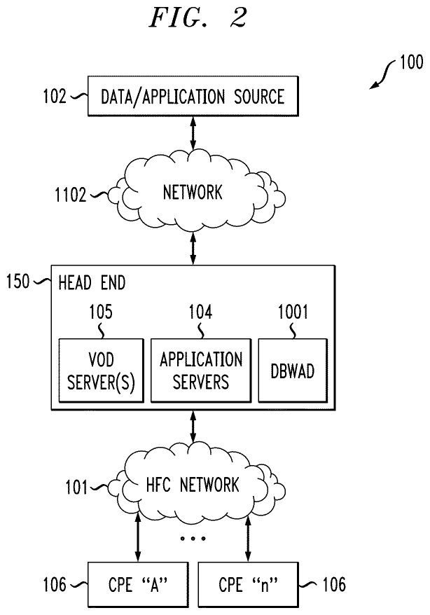

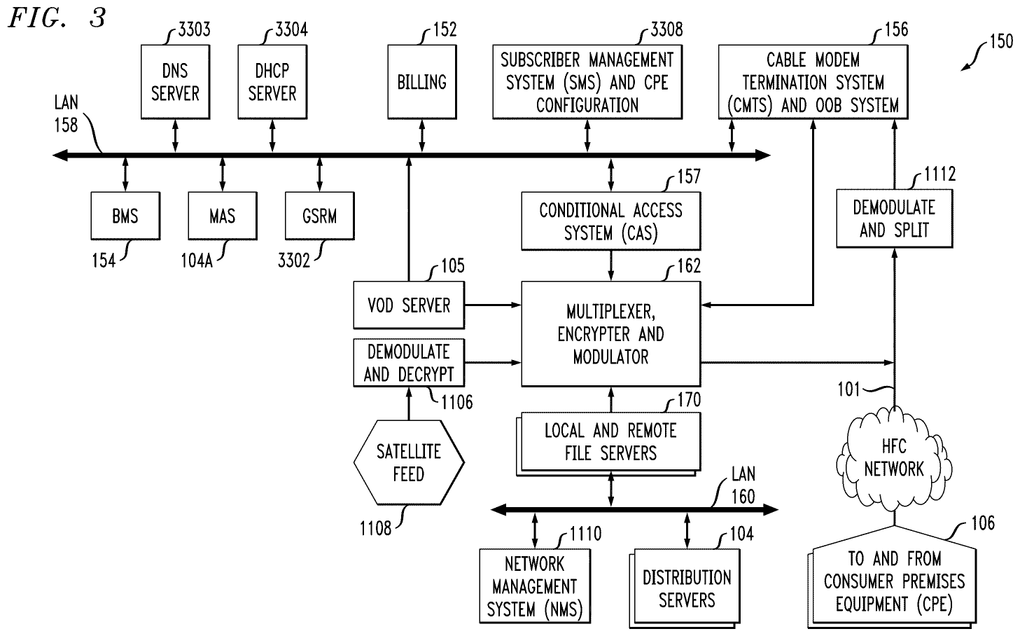

FIG. 2 is a functional block diagram illustrating an exemplary content-based (e.g., hybrid fiber-coaxial (HFC)) divisional network configuration, useful within the system of FIG. 1. Sec, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

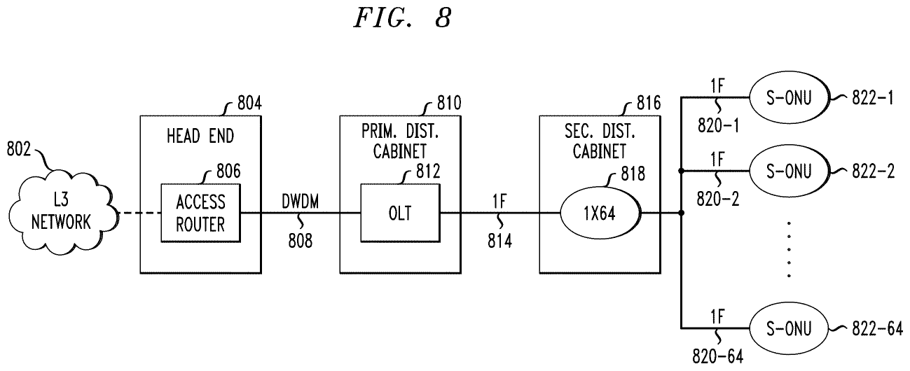

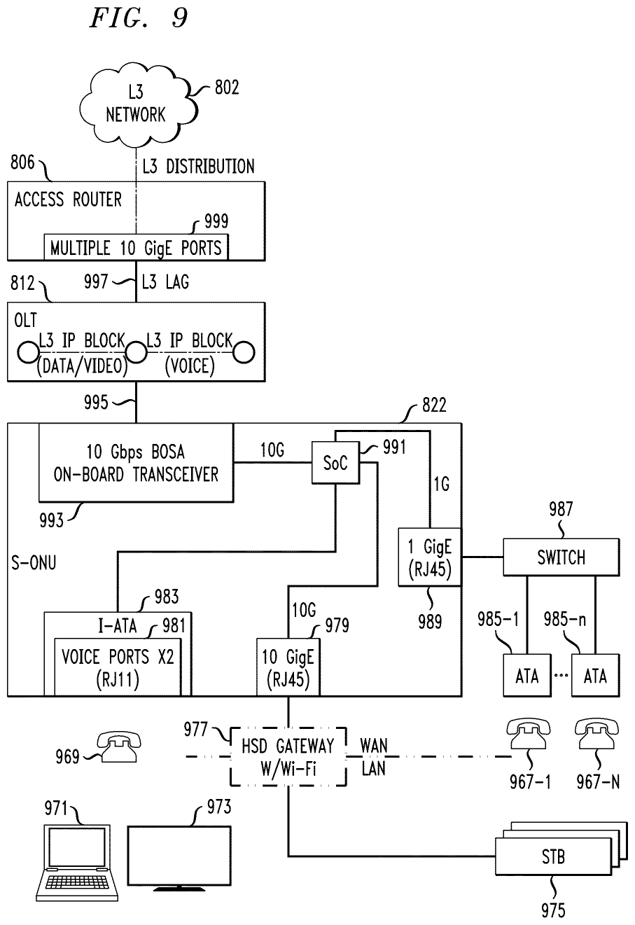

The CPE 106 includes any equipment in the “customers' premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

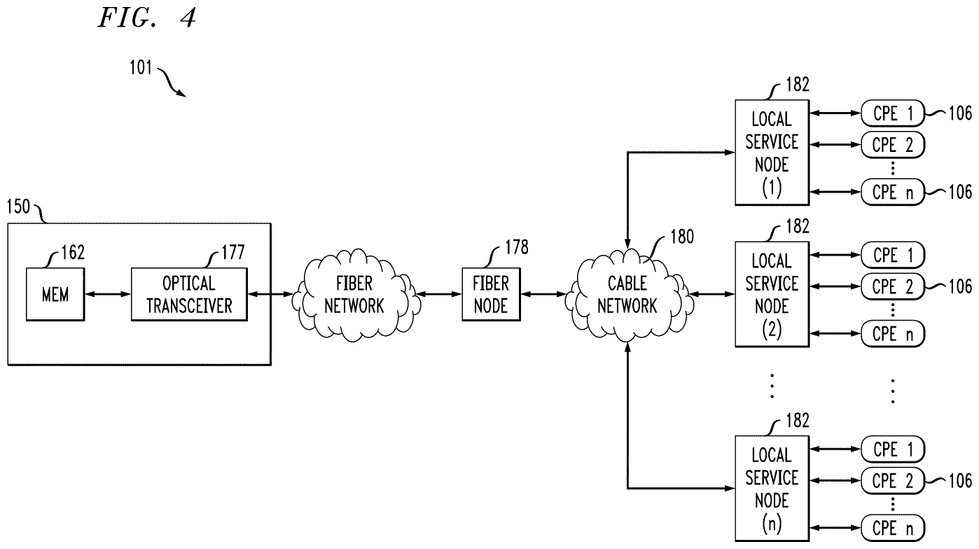

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television Laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

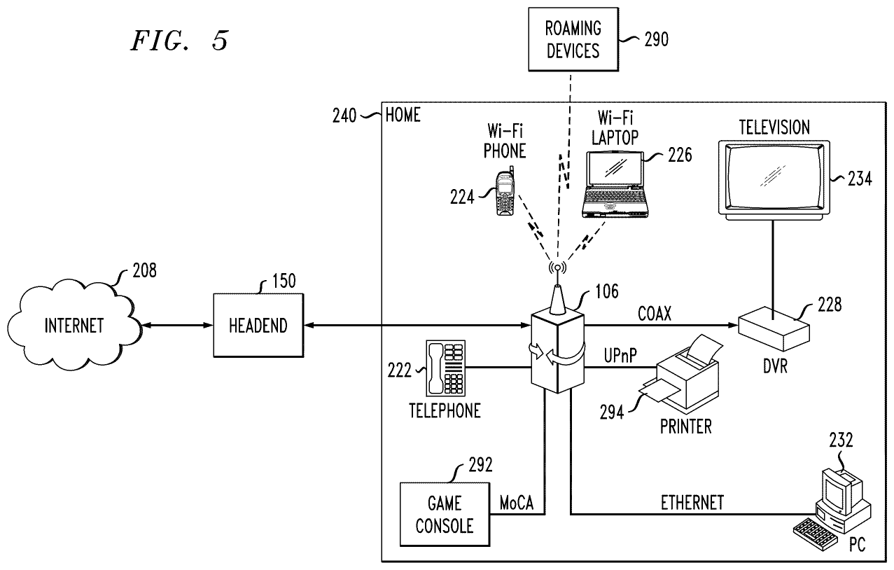

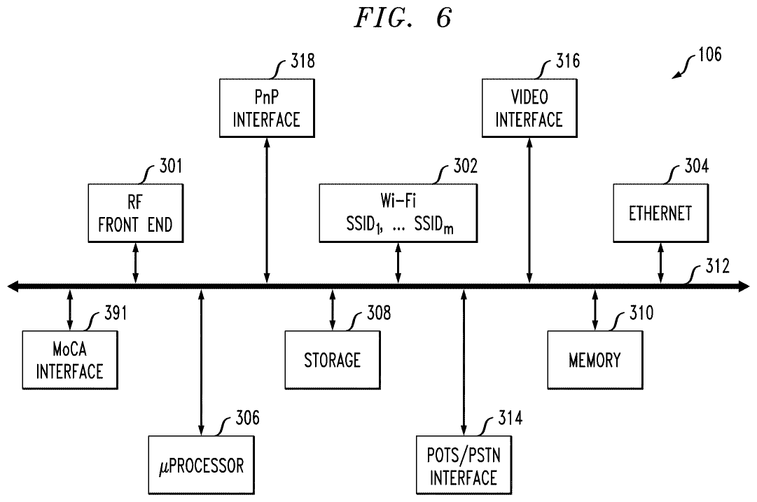

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment-see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VOIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VOIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

As noted, there are also fiber networks for fiber to the home (FTTH) deployments (also known as fiber to the premises or FTTP), where the CPE is a Service ONU (S-ONU; ONU=optical network unit). Referring now to FIG. 8, L3 network 802 generally represents the elements in FIG. 1 upstream of the head ends 150, while head end 804, including access router 806, is an alternative form of head end that can be used in lieu of or in addition to head ends 150 in one or more embodiments. Head end 804 is suitable for FTTH implementations. Access router 806 of head end 804 is coupled to optical line terminal 812 in primary distribution cabinet 810 via dense wavelength division multiplexing (DWDM) network 808. Single fiber coupling 814 is then provided to a 1:64 splitter 818 in secondary distribution cabinet 816 which provides a 64:1 expansion to sixty-four S-ONUs 822-1 through 822-64 (in multiple premises) via sixty-four single fibers 820-1 through 820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 806 is provided with multiple ten-Gigabit Ethernet ports 999 and is coupled to OLT 812 via L3 (layer 3) link aggregation group (LAG) 997. OLT 812 can include an L3 IP block for data and video, and another L3 IP block for voice, for example. In a non-limiting example, S-ONU 822 includes a 10 Gbps bi-directional optical subassembly (BOSA) on-board transceiver 993 with a 10G connection to system-on-chip (SoC) 991. SoC 991 is coupled to a 10 Gigabit Ethernet RJ45 port 979, to which a high-speed data gateway 977 with Wi-Fi capability is connected via category 5E cable. Gateway 977 is coupled to one or more set-top boxes 975 via category 5e, and effectively serves as a wide area network (WAN) to local area network (LAN) gateway. Wireless and/or wired connections can be provided to devices such as laptops 971, televisions 973, and the like, in a known manner. Appropriate telephonic capability can be provided. In a non-limiting example, residential customers are provided with an internal integrated voice gateway (I-ATA or internal analog telephone adapter) 983 coupled to SoC 991, with two RJ11 voice ports 981 to which up to two analog telephones 969 can be connected. Furthermore, in a non-limiting example, business customers are further provided with a 1 Gigabit Ethernet RJ45 port 989 coupled to SoC 991, to which switch 987 is coupled via Category 5e cable. Switch 987 provides connectivity for a desired number n (typically more than two) of analog telephones 967-1 through 967-n, suitable for the needs of the business, via external analog telephone adapters (ATAs) 985-1 through 985-n. The parameter “n” in FIG. 9 is not necessarily the same as the parameter “n” in other figures, but rather generally represents a desired number of units. Connection 995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

As noted above, an MSO can have millions of field-deployed access devices. Maintaining and running this large network requires a significant amount of diagnostic effort from field technicians who must keep working on resolving different issues. Typically, a technician spends several hours to diagnose and mitigate an issue, along with waiting to obtain a response from expert engineers who analyze and provide a “fix” for the issue. As also noted, one or more embodiments advantageously enhance Distributed Access Architecture (DAA) deployment, including RPD (Remote PHY Device) deployment, by assisting in the diagnosis of issues that might be encountered when implementing these network upgrades

One or more embodiments advantageously take advantage of the advancement of artificial intelligence (AI) to reduce this diagnostic interval and/or improve the network performance at the same time. This can be accelerated, for example, by the use of generative AI, particularly LLMs, which are thought to be the foundation for self-governing, interacting AI agents.

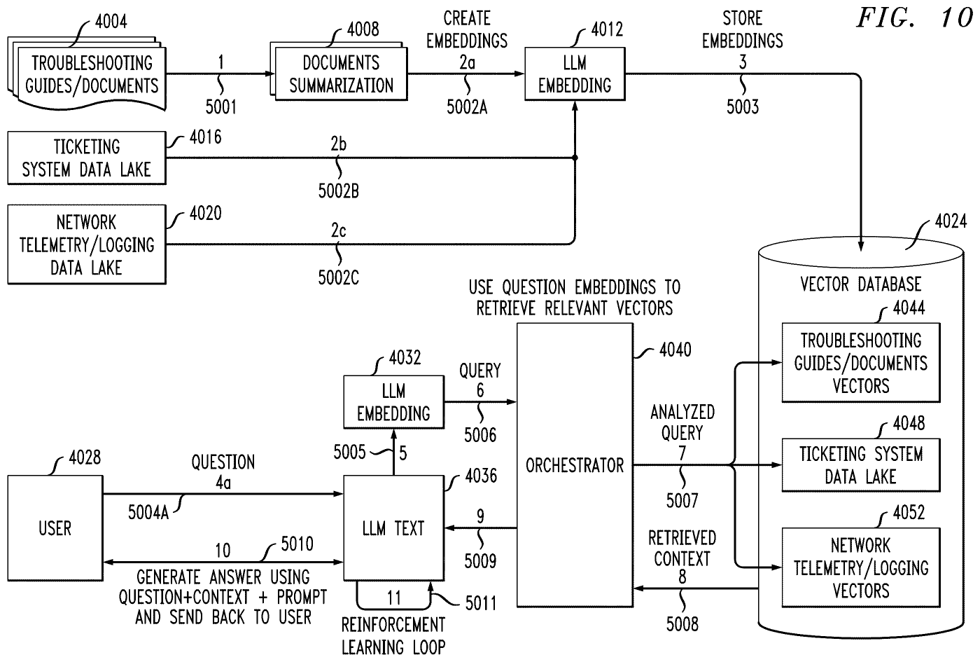

In one or more exemplary embodiments, a Retrieval-Augmented Generation (RAG) approach is used to create an intelligent diagnostic system, which can help field technicians in troubleshooting and fixing field issues much faster than prior art techniques. Referring to the exemplary combined system block diagram/data flow diagram of FIG. 10, one or more embodiments implement the below-described architecture and method steps.

### Data Collection

Referring to elements 4004, 4016, 4020 in FIG. 10, the following data sources are used in one or more exemplary embodiments: streaming telemetry data/logging data 4020; field issues ticketing system data 4016; and troubleshooting guides/documents 4004.

### Documents Summarization

As documents 4004 can be very large, one or more embodiments employ a document summarization model library 4008 (e.g. LANGCHAIN software available from LangChain Inc., San Francisco, CA, USA), to summarize the documents, which will advantageously reduce the size of the text to be sent to the LLM.

### Vector Embedding

As seen at 4012, the embedding transforms the datasets retrieved from the data collection step and the summarization text into a vector representation referred to as an embedding. The LLM embedding block 4012 encodes each data chunk into a high-dimensional vector. This process captures the semantic information of the text in the form of a vector.

### Vector Database

The vector embedding is stored in a vector database 4024 (e.g., WEAVIATE® software available from Weaviate B.V., Amsterdam, The Netherlands), which enables efficient semantic search using different algorithms such as a “cosine similarity” algorithm among the vectors, and which helps in retrieving the most relevant documents/logs/ticketing system data for a given query.

### Query Analysis and Processing

In one or more embodiments, when a user 4028 asks a question, the LLM text model 4036 converts the question into a vector (embedding) 4032, similar to the above-discussed embedding steps.

### Context Retrieval

One or more embodiments advantageously employ an orchestrator 4040 in the RAG architecture, which analyzes the notion of the users' query vector, searches the query vector in the relevant vector database section (e.g., 4044, 4048, or 4052 as the case may be, discussed elsewhere herein) and retrieves the relevant context from the vector database. For example, if the user asks, “did a similar field issue occur in the past?” the orchestrator 4040 searches for the query vector in the vector database where the field issue ticketing system data embedding is stored (i.e., at 4048) and will retrieve the most semantically similar vectors to the query vector. Another example is when a user asks, “what are the suggested troubleshooting steps for this issue?” and the orchestrator 4040 will retrieve the vectors from the troubleshooting guide dataset embeddings 4044 along with the current network telemetry data 4052 from the vector database. The text data associated with these vectors is the most relevant data to the query and will serve as context for the LLM.

### Answer Generation

In one or more embodiments, using the query and prompt along with the previously-retrieved context, the LLM text model 4036 generates the answer. For example, model 4036 can utilize the following exemplary prompt structure (the following is a non-limiting example to illustrate distinguishing between information that would be specific to an automotive provider versus an MSO):
Prompt=“Follow these steps:
1. Read the context and aggregate this data.
   Context: {matching engine response}
2. Answer the question only using this context.
3. Show the source of your answers.
User Question: {question}
If Question is out of context (e.g., not AUTOMOTIVE domain related), reply that “Please ask questions related to AUTOMOTIVE domain only as I am not trained on the context out of AUTOMOTIVE domain”. If you don't have any context and are unsure of the answer, reply that you don't know the answer and are always learning.”

### Feedback for Reinforcement Learning

Referring to the reinforcement learning loop in FIG. 10, one or more embodiments advantageously provide reinforcement learning in the generally available RAG architecture. Once the answer is generated (arrow 5010 from 4036 to 4028), the feedback of the human user (arrow 5010 from 4028 to 4036) is recorded using the feedback loop 5011 to implement reinforcement learning from human feedback (RLHF), which trains a reward model, optimizes a policy using proximal policy optimization (PPO), and then fine-tunes the LLM 4036 using that policy to improve the performance.

One or more embodiments are believed capable of significantly reducing network operations troubleshooting time (which currently can take 6-8 hours just to get an answer from the experts), and/or at the same time improve the customer service and customer experience, as there will be less service downtime. One or more embodiments provide a solution that can be integrated with any Android®-based (registered mark of GOOGLE LLC Mountain View, CA, US) smart phone, iOS®-based (registered mark of Cisco Technology, Inc. San Jose, CA, US; “smart” phones using the iOS operating system are available from Apple Inc., Cupertino, California, USA) smart phone, or web application (“APP”) to create a troubleshooting/diagnostic application enriched with Generative AI, which can be used by technicians in the field or anyone who needs immediate answers to questions.

One or more embodiments thus advantageously apply generative AI to a broadband/telecommunications network, by adding operational intelligence to reduce the diagnostic interval and/or improve the network performance for a variety of networks; non-limiting exemplary networks include an HFC network depicted in FIGS. 1-6 and a fiber network depicted in FIGS. 8 and 9. Elements of the invention can be located, for example, in the cloud, in a national data center, in a regional data center, in a head end, or the like. Unlike current AI solutions, which depend on the existence of documentation from which they extract information to create an interactive knowledge base, one or more embodiments add logging and telemetry data 4020 along with ticketing system data 4016 to further enhance the learning capability of generative AI. One or more embodiments advantageously include either one or both of two new components in a RAG Architecture: (1) the orchestrator 4040 which analyzes the query vector before searching it directly in the vector database 4024 (which reduces context retrieval latency); and/or (2) reinforcement learning using human feedback (RLHF) loop 5011 to improve the efficacy of the LLM 4036 over time in generating more coherent answers.

By way of a further non-limiting exemplary use case, consider a technician who is trying to troubleshoot a field issue. The technician 4028 opens an AI model integrated APP (or accesses a web page) and searches whether there are similar issues that have occurred in the past. An AI model analyzes this query, retrieves the context, and generates a list of similar issues from the past. Next, the technician asks for troubleshooting steps for the current issue, The AI model analyzes the query, obtains the context from troubleshooting guides and current network telemetry, and generates the troubleshooting steps based on its past learning, current context, and prompt. Advantageously, this can be accomplished within a few seconds/minutes, whereas it would have taken hours before.

As will be appreciated by the skilled artisan, in the field of machine learning, reinforcement learning from human feedback (RLHF) is a technique to align an intelligent agent to human preferences. In classical reinforcement learning, the goal of such an agent is to learn a function that guides its behavior (called a policy). This function learns to maximize the reward it receives from a separate reward function based on its task performance. However, it is difficult to explicitly define a reward function that approximates human preferences. Therefore, RLHF seeks to train a “reward model” directly from human feedback. The reward model is first trained in a supervised fashion, independently from the policy being optimized, to predict if a response to a given prompt is good (high reward) or bad (low reward), based on ranking data collected from human annotators. This model is then used as a reward function to improve an agent's policy through an optimization algorithm such proximal policy optimization.

The skilled artisan will further appreciate that RAG is an AI framework for retrieving facts from an external knowledge base to ground large language models (LLMs) on the most accurate, up-to-date information and to give users insight into LLMs' generative process.

Still referring to FIG. 10, which depicts a multi-modal LLM architecture, recall that MSOs typically have a large network in the field. Issues arise from time to time; for example, with respect to the DOCSIS environment, access network, or the like. When a technician carries out a field visit (“truck roll”), it often takes 6-8 hours to diagnose an issue, including obtaining assistance from a network engineer or other human SME, and to effectuate a “fix.” This potentially results in a large expenditure of time and a negative impact on customer service. One or more embodiments advantageously apply generative AI, especially LLMs, to reduce diagnostic time, reduce down time, and improve network performance.

In one aspect, any suitable type of LLM is fine-tuned on existing data. Suppose there is a robust data set; for example, a knowledge base such as collaboration software pages. A pre-trained LLM can be employed, and fine-tuned on this data. An architecture can be created where, when a user/technician 4028 asks a question, a response can be generated based on the fine-tuned (trained) LLM. In this aspect of training, a human subject matter expert (SME) annotates training data, which is used to train a model that is then deployed for inferencing. In the field of generative AI/natural language processing, when an LLM is trained with domain-specific data, it is referred to as fine tuning. A drawback is that network-related data is very dynamic; new data is obtained every day. Another drawback is that fine-tuning is expensive, requiring a large amount of computational resources.

To address these drawbacks, one or more embodiments adapt the above-discussed RAG approach. A pre-trained LLM is still employed. Referring to FIG. 10, an architecture is created where it is not necessary to fine-tune the model. Whenever the user 4028 submits a query 5004A, the system will search the database 4024 based on provided guardrails/guidelines, and will provide a suitable output at 5010. This approach advantageously provides the flexibility of obtaining the latest data and context from the database/knowledge base, and the LLM 4036 can carry out its own answer generation based on the latest data.

The dataset includes existing knowledge base 4004 (e.g., troubleshooting guides/documents-including specifications and device manuals/standards); ticketing system data lake 4016 (e.g., JIRA® ticket database (registered mark of Atlassian Pty Ltd Sydney AUSTRALIA), or any other ticketing system, with logged details of past issues such as error logs and troubleshooting/diagnostic steps taken, and fix taken); and network telemetry and logging database 4020, which can be obtained directly from field devices. Any suitable protocol/technique can be used to stream telemetry data; one non-limiting example is the MQTT (Message Queuing Telemetry Transport) protocol using Kafka Streams (Apache® Kafka is an open-source distributed event streaming platform, registered mark of The Apache Software Foundation, Wilmington, DELAWARE, US). Because the technical and standards documents in existing knowledge base 4004 are typically quite large, in one or more embodiments, carry out documents summarization as shown at 4008 and step 5001; for example, using any suitable PYTHON, C, or other library, whether open source or otherwise; LANGCHAIN is a non-limiting example of a suitable library. At 4008, the documents are summarized and placed into small document chunks, which makes it easier for the LLM to handle the text. Then, as per step 5002A, create vector embeddings at 4012, for all the summarized documents, tickets, and telemetry data. Creating vector embeddings from the text data enhances the functionality of the LLM. See the discussion of vector embedding above. An LLM is used to carry out the embedding in one or more embodiments as known from the field of natural language processing (NLP). The embeddings are then stored in a vector database 4024 in step 5003. As seen at 5002B and 5002C, data from 4016 and 4020 can proceed directly to block 4012 without summarization in the depicted example. Based on cosine similarity, for example, the vectors are stored in the database 4024.

Based on the semantic meaning of the text data, one or more embodiments store in special locations (separate partitions). Note the separate partitions in the vector database for troubleshooting guides and documents at 4044; for ticketing system data at 4048; and for network telemetry/logging vectors at 4052 (corresponding to elements 4004, 4016, and 4020, respectively). This advantageously assists in vector data retrieval, reducing the latency for vector retrieval. As new data dynamically comes in, for example, to elements 4016 or 4020, the data keeps updating and storing in the vector database 4024.

Again consider an exemplary answer retrieval process. One or more embodiments can employ an “APP” or a web-based interface with the user 4028 (e.g., a technician) to permit the user to enter the user's query at 5004A. The user queries the LLM 4036 with a textual query (or audio to text interface to simplify the user experience), which is converted to a vector embedding at 4032 (step 5005). Consider now the orchestrator component 4040, which advantageously reduces the latency of data retrieval from the vector database 4024. The orchestrator 4040 (which, in one or more embodiments, is implemented as an LLM), obtains the embedding in step 5006 and analyzes the vector embedding of the query, based on a notion of the query (i.e., what type of query it is). For example, the user 4028 can ask whether a certain issue has occurred in the past. In response, the orchestrator 4040 analyzes the query, checks the ticketing system data lake 4048, and retrieves the relevant context. Note querying in step 5007 and retrieval in step 5008 The retrieved context is provided back to the LLM Text model 4036 in step 5009. Based on the retrieved context and the query, the LLM text model 4036 tries to generate the answer.

Refer to the discussion of prompting under Answer Generation above. The context retrieved from the vector database 4024 is read. Using that context and its previous knowledge, the LLM Text model 4036 will seek to generate the answer. One or more embodiments also include a guardrail in the prompt/while generating the answer. See the discussion of “question is out of context” above; this aspect can also be implemented in the LLM text model 4036. The generated answer is then output to the user in step 5010 (left-hand flow).

Note the reinforcement learning loop 5011. Suppose, for example, that the LLM text model 4036 initially generates some out-of-context or otherwise inappropriate (e.g., insufficiently specific) answers. The user can provide feedback such as “this is not related” or “can you be more specific?” (arrow 5010 right-hand flow). A reward can be created in the RLL 11 based on the feedback; positive feedback leads to a positive reward while negative feedback leads to a negative reward. Embodiments of the invention are not limited to any specific reward function. Indeed, in one or more embodiments, if a user responds with negative feedback, e.g., “this is out of context,” this will be taken as negative feedback and a previously generated answer will be taken as a rejected answer and a negative reward will be given. The LLM will try to improve based on PPO policy and try to retrieve a new context if possible and generate an answer with the newly obtained context based on this learning. If the user gives a positive response, e.g., “this is good” or “can you be more specific,” a positive reward will be given and the LLM will try to optimize the previously generated answer. For the avoidance of doubt, one or more embodiments do not change the LLM per se even for negative feedback from the user 4028. Rather, one or more embodiments update the PPO policy based on the feedback and fine-tune the LLM with the updated policy. Furthermore in this regard, in one or more embodiments, the LLM will not be changed, but will be updated. If the user responds with negative feedback, e.g., “this is out of context,” this will be taken as negative feedback and the previously generated answer will be taken as a rejected answer and a negative reward will be given. The LLM will try to improve based on PPO policy and will try to retrieve a new context if possible and to generate an answer with newly obtained context based on this learning.

Further regarding the orchestrator 4040, any ML classifier can be adapted. ML components herein can be implemented in software on a general-purpose computer, software on a special purpose computer such as an array of graphical processing units, with use of a hardware accelerator, with special-purpose hardware, or the like. Orchestrator 4040 can be, for example, an LLM that will analyze a query to create a semantic relationship between the query (e.g., words) and one of the vector DB sections (partitions), and to extract the notion. Thus, in one or more embodiments, this classification model will be, for example, a pre-trained classifier model which will classify a query based on the words (with their semantic meaning) to one of the vector DB sections (partitions). The model that implements the orchestrator can be trained on, for example, what ticketing system data looks like, what telemetry system data looks like, and so on, essentially acting as a classification model to classify the query as technical document related, ticketing system related, telemetry related, and so on. For example, user 4028 could inquire as to the current network situation for a particular node. The orchestrator will classify this as network telemetry related and will accordingly fetch the network telemetry vectors from the vector database and provide same to model 4036 to generate the answer.

One or more embodiments advantageously provide a combined approach looking for relationships between elements 4004, 4016, 4020, where all three sources feed LLM embeddings 4012 to enhance system efficiency and pattern recognition to create vectors in database 4024.

Given the discussion thus far, it will be appreciated that, in general terms, an exemplary computer-implemented method, according to an aspect of the invention, includes the step of at a large language model, converting a user query to an embedded version of the user query. This can be done, for example, using LLM embedding 4032. A further step includes analyzing the embedded version of the query with an orchestrator to obtain a notion of the query. This can be done, for example, with the orchestrator 4040. The analyzed query is the notion in one or more embodiments. In one or more embodiments, the orchestrator is an LLM. For example, a pretrained LLM text classification model classifies queries as related to ticketing, telemetry, or troubleshooting guides and the like. The LLM can be implemented using known techniques such as software on a general purpose computer, software on a special computer such as an array of graphical processing units (GPUs), using a hardware accelerator, and the like

Further steps include querying a vector database 4024 with the notion of the query; responsive to the querying of the vector database, retrieving a context with the orchestrator 4040; providing the context from the orchestrator to the large language model at 5009; generating an answer to the user query with the large language model based on the user query and the context; and returning the generated answer to the user at 5010.

As will be appreciated by the skilled artisan, a vector database is a database that indexes and stores vector embeddings for fast retrieval and similarity search as known to skilled artisan in the field of AI. Databases, data lakes, data structures, and the like are known per se, but one or more embodiments populate same with novel contents and put same to novel use(s). Given the teachings herein, elements 4008 and 4012 can be implemented by adapting known techniques from natural language processing (NLP) and parsing. In a non-limiting example, data lakes can be implemented using DATABRICKS® software (registered mark of Databricks, Inc. San Francisco, CA, USA), SNOWFLAKE® software (registered mark of SNOWFLAKE INC. Bozeman, MT, USA), or the like.

As noted, one or more embodiments advantageously use reinforcement learning (RL) in an Retrieval-Augmented Generation (RAG) context. Thus, one or more embodiments further include obtaining feedback from the user at the large language model; and carrying out reinforcement learning with the large language model based on the human feedback. Refer to step 5011.

It is worth noting that the user 4028 can interact with the system, for example, using a user interface such as a web page (html served out by a server to a client of the user), an application (“app”) running on a user's device, and the like.

In some cases, the step of carrying out reinforcement learning updates a policy of the large language model and fine-tunes the large language model based on the updated policy, and the process is repeated with the updated model. Thus, further steps include: with the fine-tuned large language model, converting a second user query to an embedded version of the second user query; analyzing the embedded version of the second user query with the orchestrator to obtain a notion of the second user query; querying the vector database with the notion of the second user query; responsive to the querying of the vector database with the notion of the second user query, retrieving a second context with the orchestrator; providing the second context from the orchestrator to the fine-tuned large language model; generating an answer to the second user query with the fine-tuned large language model based on the second user query and the second context; and returning the generated answer to the second user query to the user.

Generally, one or more embodiments implement specifics of reinforcement learning from human feedback (RLHF), which trains a reward model, optimizes a policy using proximal policy optimization (PPO), and then fine-tunes the LLM 4036 using that policy to improve the performance.

When the user feedback is negative, the reinforcement learning will change a policy of the large language model and fine-tune the large language model based on the updated policy. For example, the LLM will not be changed but will be updated-if the user responds with negative feedback such as “this is out of context,” this will be taken as negative feedback and the previously generated answer will be taken as a rejected answer and a negative reward will be given. The LLM will try to improve based on the updated PPO policy and will try to retrieve a new context if possible and generate answer with the newly obtained context based on this learning.

On the other hand, in some instances, the user feedback is positive and the step of carrying out reinforcement learning maintains the existing large language model policy. Thus, further steps in this aspect include: with the large language model with maintained policy, converting a second user query to an embedded version of the second user query; analyzing the embedded version of the second user query with the orchestrator to obtain a notion of the second user query; querying the vector database with the notion of the second user query; responsive to the querying of the vector database with the notion of the second user query, retrieving a second context with the orchestrator; providing the second context from the orchestrator to the large language model with maintained policy; generating an answer to the second user query with the large language model with maintained policy based on the second user query and the second context; and returning the generated answer to the second user query to the user.

In one or more embodiments, the user query pertains to network troubleshooting. Accordingly, one or more embodiments further include populating the vector database 4024 with entries relevant to the network troubleshooting. For example, populating the vector database can include: storing vector embeddings 4044 pertaining to troubleshooting guides and documents; storing vector embeddings 4048 pertaining to a ticketing system; and storing vector embeddings 4052 pertaining to network telemetry and logging.

In one or more embodiments, the contents of the vector database 4024 are updated on an ongoing basis by summarizing the troubleshooting guides and documents 4004 at 4008 to create summaries and creating the vector embeddings (see 4012) pertaining to the troubleshooting guides and documents from the summaries; creating the vector embeddings (see 4012) pertaining to the ticketing system from a ticketing system data lake 4016; and creating the vector embeddings (see 4012) pertaining to network telemetry and logging from a network telemetry and logging data lake 4020.

One or more embodiments further include carrying out a network repair based on the generated answer.

In another aspect, a non-transitory computer readable medium includes computer executable instructions which when executed by a computer cause the computer to perform or otherwise facilitate any one, some, or all of the method steps disclosed herein.

In a further aspect, an apparatus includes a memory 730 and at least one processor 720, coupled to the memory, and operative to perform or otherwise facilitate any one, some, or all of the method steps disclosed herein. Furthermore, the at least one processor is optionally further operative to instantiate any one, some, or all of the components described and illustrated, such as the large language model, the orchestrator, and the vector database.

In a still further aspect, a system includes a large language model configured to convert a user query to an embedded version of the user query; an orchestrator coupled to the large language model and configured to analyze the embedded version of the query to obtain a notion of the query; and a vector database coupled to the orchestrator. The orchestrator is further configured to: query the vector database with the notion of the query; responsive to the querying of the vector database, retrieve a context; and provide the context to the large language model. The large language model is further configured to: generate an answer to the user query based on the user query and the context; and return the generated answer to the user.

In some instances, the large language model is further configured to: obtain feedback from the user; and carry out reinforcement learning based on the human feedback.

In one or more embodiments, the vector database is populated with entries relevant to network troubleshooting.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

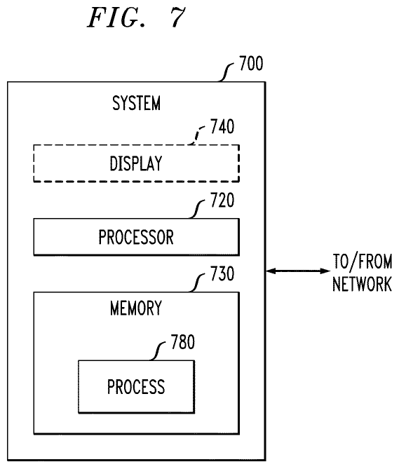

FIG. 7 is a block diagram of at least a portion of an exemplary system 700 that can be configured to implement at least some aspects of the invention, and is representative, for example, of one or more of the apparatuses, servers, or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC or FPGA rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A computer-implemented method comprising:
at a large language model, converting a user query to an embedded version of the user query;
analyzing the embedded version of the query with an orchestrator to obtain a notion of the query;
querying a vector database with the notion of the query;
responsive to the querying of the vector database, retrieving a context with the orchestrator;
providing the context from the orchestrator to the large language model;
generating an answer to the user query with the large language model based on the user query and the context; and
returning the generated answer to the user.

2. The computer-implemented method of claim 1, further comprising:
obtaining feedback from the user at the large language model; and
carrying out reinforcement learning with the large language model based on the human feedback.

3. The computer-implemented method of claim 2, wherein the step of carrying out reinforcement learning updates a policy of the large language model and fine-tunes the large language model based on the updated policy, further comprising:
with the fine-tuned large language model, converting a second user query to an embedded version of the second user query;
analyzing the embedded version of the second user query with the orchestrator to obtain a notion of the second user query;
querying the vector database with the notion of the second user query;
responsive to the querying of the vector database with the notion of the second user query, retrieving a second context with the orchestrator;
providing the second context from the orchestrator to the fine-tuned large language model;
generating an answer to the second user query with the fine-tuned large language model based on the second user query and the second context; and
returning the generated answer to the second user query to the user.

4. The computer-implemented method of claim 3, wherein the user feedback is negative.

5. The computer-implemented method of claim 2, wherein the user feedback is positive and the step of carrying out reinforcement learning maintains an existing large language model policy, further comprising:
with the large language model with maintained policy, converting a second user query to an embedded version of the second user query;
analyzing the embedded version of the second user query with the orchestrator to obtain a notion of the second user query;
querying the vector database with the notion of the second user query;
responsive to the querying of the vector database with the notion of the second user query, retrieving a second context with the orchestrator;
providing the second context from the orchestrator to the large language model with maintained policy;
generating an answer to the second user query with the large language model with maintained policy based on the second user query and the second context; and
returning the generated answer to the second user query to the user.

6. The computer-implemented method of claim 2, wherein the user query pertains to network troubleshooting.

7. The computer-implemented method of claim 6, further comprising populating the vector database with entries relevant to the network troubleshooting.

8. The computer-implemented method of claim 7, wherein populating the vector database with the entries relevant to the network troubleshooting comprises:
storing vector embeddings pertaining to troubleshooting guides and documents;
storing vector embeddings pertaining to a ticketing system; and
storing vector embeddings pertaining to network telemetry and logging.

9. The computer-implemented method of claim 7, further comprising, on an ongoing basis:
summarizing the troubleshooting guides and documents to create summaries and creating the vector embeddings pertaining to the troubleshooting guides and documents from the summaries;
creating the vector embeddings pertaining to the ticketing system from a ticketing system data lake; and
creating the vector embeddings pertaining to network telemetry and logging from a network telemetry and logging data lake.

10. The computer-implemented method of claim 6, further comprising carrying out a network repair based on the generated answer.

11. A non-transitory computer readable medium comprising computer executable instructions which when executed by a computer cause the computer to perform the method of:
at a large language model, converting a user query to an embedded version of the user query;
analyzing the embedded version of the query with an orchestrator to obtain a notion of the query;
querying a vector database with the notion of the query;
responsive to the querying of the vector database, retrieving a context with the orchestrator;
providing the context from the orchestrator to the large language model;
generating an answer to the user query with the large language model based on the user query and the context; and
returning the generated answer to the user.

12. The non-transitory computer readable medium of claim 11, wherein the method further comprises:
obtaining feedback from the user at the large language model; and
carrying out reinforcement learning with the large language model based on the human feedback.

13. An apparatus comprising:
a memory; and
at least one processor, coupled to the memory, and operative to:
at a large language model, convert a user query to an embedded version of the user query;
analyze the embedded version of the query with an orchestrator to obtain a notion of the query;
query a vector database with the notion of the query;
responsive to the querying of the vector database, retrieve a context with the orchestrator;
provide the context from the orchestrator to the large language model;
generate an answer to the user query with the large language model based on the user query and the context; and
return the generated answer to the user.

14. The apparatus of claim 13, wherein the at least one processor is further operative to instantiate the large language model, the orchestrator, and the vector database.

15. The apparatus of claim 14, wherein the at least one processor is further operative to:
obtain feedback from the user at the large language model; and
carry out reinforcement learning with the large language model based on the human feedback.

16. The apparatus of claim 15, wherein the at least one processor is operative to carry out the reinforcement learning to update a policy of the large language model and fine-tunes the large language model based on the updated policy, and wherein the at least one processor is further operative to:
with the fine-tuned large language model, convert a second user query to an embedded version of the second user query;
analyze the embedded version of the second user query with the orchestrator to obtain a notion of the second user query;
query the vector database with the notion of the second user query;
responsive to the querying of the vector database with the notion of the second user query, retrieve a second context with the orchestrator;
provide the second context from the orchestrator to the fine-tuned large language model;
generate an answer to the second user query with the fine-tuned large language model based on the second user query and the second context; and
return the generated answer to the second user query to the user.

17. The apparatus of claim 16, wherein the user feedback is negative.

18. The apparatus of claim 15, wherein the user feedback is positive and the at least one processor is operative to carry out the reinforcement learning to maintain an existing large language model policy, and wherein the at least one processor is further operative to:
at the existing large language model, convert a second user query to an embedded version of the second user query;
analyze the embedded version of the second user query with the orchestrator to obtain a notion of the second user query;
query the vector database with the notion of the second user query;
responsive to the querying of the vector database with the notion of the second user query, retrieve a second context with the orchestrator;
provide the second context from the orchestrator to the large language model with maintained policy;
generate an answer to the second user query with the large language model with maintained policy based on the second user query and the second context; and
return the generated answer to the second user query to the user.

19. The apparatus of claim 15, wherein the user query pertains to network troubleshooting.

20. The apparatus of claim 19, wherein the at least one processor is further operative to populate the vector database with entries relevant to the network troubleshooting.

21. The apparatus of claim 20, wherein the at least one processor is operative to populate the vector database with entries relevant to the network troubleshooting by:
storing vector embeddings pertaining to troubleshooting guides and documents;
storing vector embeddings pertaining to a ticketing system; and
storing vector embeddings pertaining to network telemetry and logging.

22. The apparatus of claim 21, wherein the at least one processor is operative to, on an ongoing basis:
summarize the troubleshooting guides and documents to create summaries and creating the vector embeddings pertaining to the troubleshooting guides and documents from the summaries;
create the vector embeddings pertaining to the ticketing system from a ticketing system data lake; and
create the vector embeddings pertaining to network telemetry and logging from a network telemetry and logging data lake.

23. A system comprising:
a large language model configured to convert a user query to an embedded version of the user query;
an orchestrator coupled to the large language model and configured to analyze the embedded version of the query to obtain a notion of the query; and
a vector database coupled to the orchestrator;
wherein the orchestrator is further configured to:
query the vector database with the notion of the query;
responsive to the querying of the vector database, retrieve a context; and
provide the context to the large language model; and
wherein the large language model is further configured to:
generate an answer to the user query based on the user query and the context; and
return the generated answer to the user.

24. The system of claim 23, wherein the large language model is further configured to:
obtain feedback from the user; and
carry out reinforcement learning based on the human feedback.

25. The system of claim 24, wherein the vector database is populated with entries relevant to network troubleshooting.
